(19) United States
(12) Patent Application Publication
(10) Pub. No.: US 2019/0041666 A1
(43) Pub. Date: Feb. 7, 2019

(54) ELECTRONICALLY REINFORCED HEAD-WEARABLE APPARATUS AND RELATED METHODS

(71) Applicants: Nicolas Abele, Lausanne (CH); Michel Olivieri, Echallens (CH)

(72) Inventors: Nicolas Abele, Lausanne (CH); Michel Olivieri, Echallens (CH)

(21) Appl. No.: 15/857,219

(22) Filed: Dec. 28, 2017

(51) Int. Cl. G02C 11/00

(52) U.S. Cl. CPC G02C 11/10

(57) ABSTRACT

Electronically reinforced head-wearable apparatus and related methods are disclosed. Example glasses include a frame to carry a first lens. The frame defines a first body. A first stem and a second stem are to couple to the frame. The first stem and the second stem define a second body and a third body, respectively. A circuit board defines a circuit to implement the glasses. The circuit board is shaped to define a framework of at least one of the first body of the frame, the second body of the first stem or the third body of the second stem.

### FIELD OF THE DISCLOSURE

This disclosure relates generally to wearable electronic devices, and, more particularly, to electrically reinforced head-wearable apparatus and related methods.

### BACKGROUND

Wearable devices such as head-wearable displays, provide computing devices in the form of glasses (e.g., smart glasses). Wearable devices typically include conventional frames and stems (e.g., metal or plastic frames and stems) that support electronic components that implement the head-wearable displays. For example, the frames and/or stems and the electronic components of known wearable devices are formed as separate components or structures. The electronic components are typically assembled to the frames and/or stems via adhesive, screws and/or other fasteners. Thus, the electronic components are add-on components to conventional framework or structure defining the eyewear. Attachment of the electronic components to the framework of the head-wearable apparatus results in an increased overall dimensional profile and/or weight of the head wearable displays, which can make the head-wearable apparatus look fashionably unappealing.

### BRIEF DESCRIPTION OF THE DRAWINGS

FIG. 1A is a right, perspective view of an example head-wearable apparatus constructed in accordance with the teachings of this disclosure.

FIG. 1B is a left, perspective view of the example head-wearable apparatus of FIG. 1A.

FIG. 1C is a front view of the example head-wearable apparatus of FIGS. 1A and 1B.

FIG. 2A is a perspective, right view of the example head-wearable apparatus of FIG. 1A, but showing circuity implementing one or more electronic components of the example head-wearable apparatus of FIGS. 1A-1C.

FIG. 2B is a perspective view of an example stem of the example head-wearable apparatus of FIGS. 1A-1C and 2A.

FIG. 2C is a cross-sectional view of the example stem of FIG. 2B taken along line 2C-2C of FIG. 2B.

FIG. 3 is a perspective view of another example head-wearable apparatus disclosed herein.

FIG. 4 is a partial, perspective view of a portion of a circuit board that may implement the example head-wearable apparatus of FIG. 3.

FIG. 5 is a flowchart of an example method that may be used to manufacture an example head-wearable apparatus disclosed herein.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way positioned on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part means that there is no intermediate part between the two parts.

It should be understood that it is not necessary for a particular feature of one example to be used exclusively with that example. Instead, any of the features of an example can be combined with any other example, in addition to or in substitution for any of the other features of those examples. One example's features are not mutually exclusive to another example's features. Instead, the scope of this disclosure encompasses any combination of any of the features.

### DETAILED DESCRIPTION

Head-worn display apparatus (e.g., smart glasses) employ a computing platform to project information (e.g., digital imagery) that is super imposed over a real-world view as perceived by a user looking through the head-worn display (e.g., augmented reality). To project the digital imagery, head-worn display apparatus may employ an image source such as, for example, an optical engine or projector. To support the image source, example head-worn display apparatus may employ a frame, a stem (e.g., a temple arm or eye piece) and/or other supporting structure of a head-worn display apparatus.

Specifically, the frames or support structure of conventional head-wearable display apparatus are typically designed by a fashion designer and the electronic components are typically designed by an electronics designer. The electronic components are typically attached or coupled to external surfaces of the eyewear frame using fasteners such as, for example, adhesive, screws, etc. For example, a battery housing may be supported or carried by (e.g., positioned or coupled to) a first stem of the eyewear frames and a projection system housing may be supported or carried by (e.g., positioned or coupled to) a second stem of the eyewear frame. Due to the housings and other electronic components attached to exterior surfaces of eyewear frames, conventional head-wearable display apparatus may be relatively bulky and heavy. Thus, head-wearable display apparatus may be aesthetically and/or fashionably unappealing due to their appearance and/or weight.

Example head-wearable display apparatus disclosed herein provide a relatively smaller dimensional footprint and/or weight than conventional head-wearable display apparatus, thereby improving an aesthetic or fashionable appeal of example head-wearable apparatus disclosed herein. To provide a smaller dimensional footprint and/or weight, electronic components of example head-wearable apparatus disclosed herein may be integrally formed and/or otherwise define the frame or structure (e.g., framework) of the example head-wearable apparatus disclosed herein. As used herein, the framework means an essential supporting structure of the head-wearable apparatus (e.g., eyewear).

For example, head-wearable display apparatus disclosed herein may include a frame and/or stems composed of material(s) that define or implement electronic components of the head-wearable display apparatus. In some examples, at least a portion of the frame and/or stems of example head-wearable display apparatus disclosed herein may define or implement one or more electronic circuits (e.g., printed circuit boards PCBs). In other words, the electronic components may be formed as part of the frame and/or stems, thereby eliminating the need to fix, couple or attach a fixture or housing of an electronic component (e.g., a battery housing, a projection system housing, a sensor housing, etc.) to the frame and/or stems. As a result, the head-wearable apparatus disclosed herein provide improved aesthetic and/or fashionable appeal.

In some examples, a printed circuit board (PCB) of the head-wearable display apparatus may form or define at least a portion of a frame of example head-wearable display apparatus. In some examples, a frame of example head-wearable display apparatus disclosed herein may include a combination of relatively rigid printed circuits and relatively flexible printed circuit boards. In some examples, relatively rigid circuit boards disclosed herein may provide mechanical or structural rigidity to eyewear frame, stems and/or more generally the head-wearable apparatus. In some examples, the printed circuit boards defining at least portions of a framework of example head-wearable display apparatus disclosed herein may be overmolded with a material (e.g., a plastic material, a metallic material, etc.). In some examples, electronic components (e.g., printed circuit boards) may define a lens support frame, a first stem and/or a second stem of the head-wearable apparatus disclosed herein. In some examples, electronic components (e.g., one or more printed circuit boards) may define or form an entire dimensional footprint of a framework or structure of the example head-wearable display apparatus disclosed herein. In other words, the electronic components are not only embedded in the frame and/or the stems, but the electronic components provide the structural support, framework and/or otherwise define the shape of the frame and/or the stems.

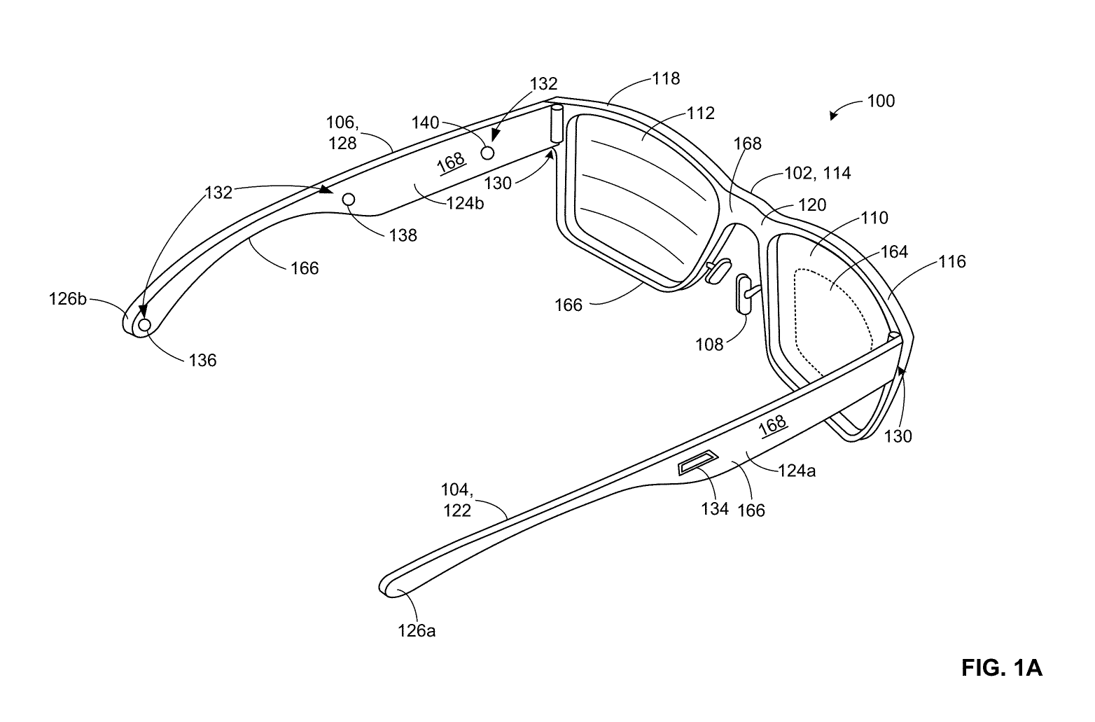

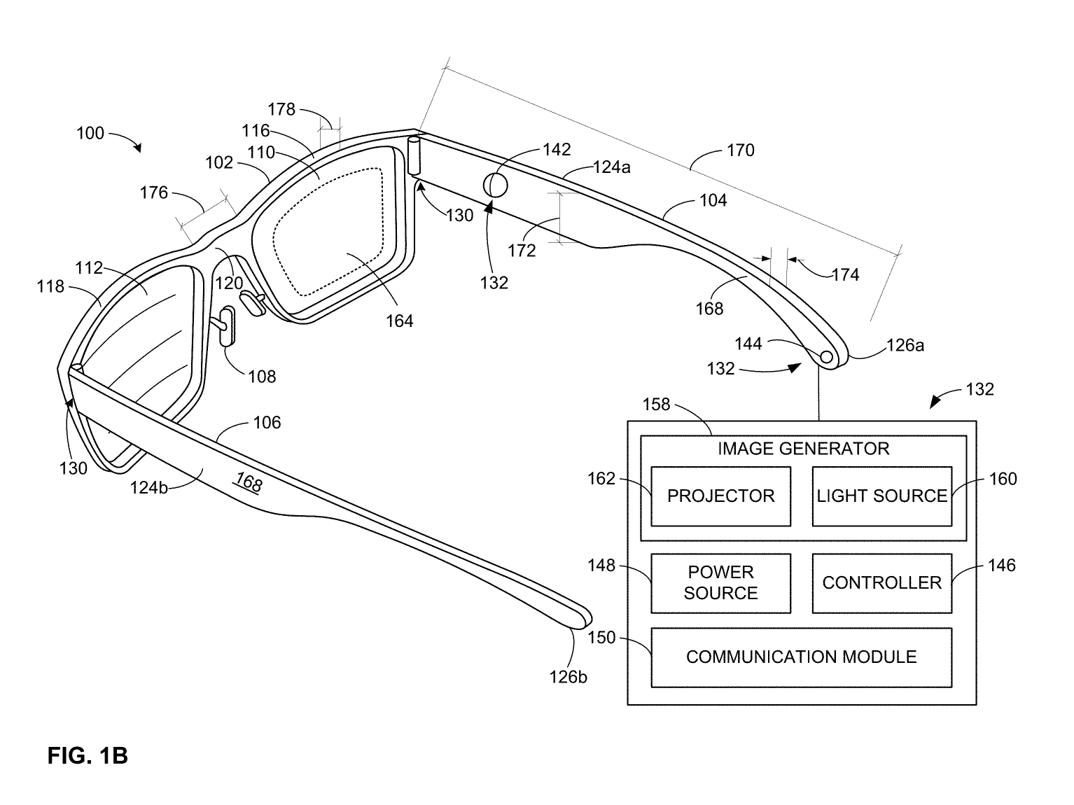

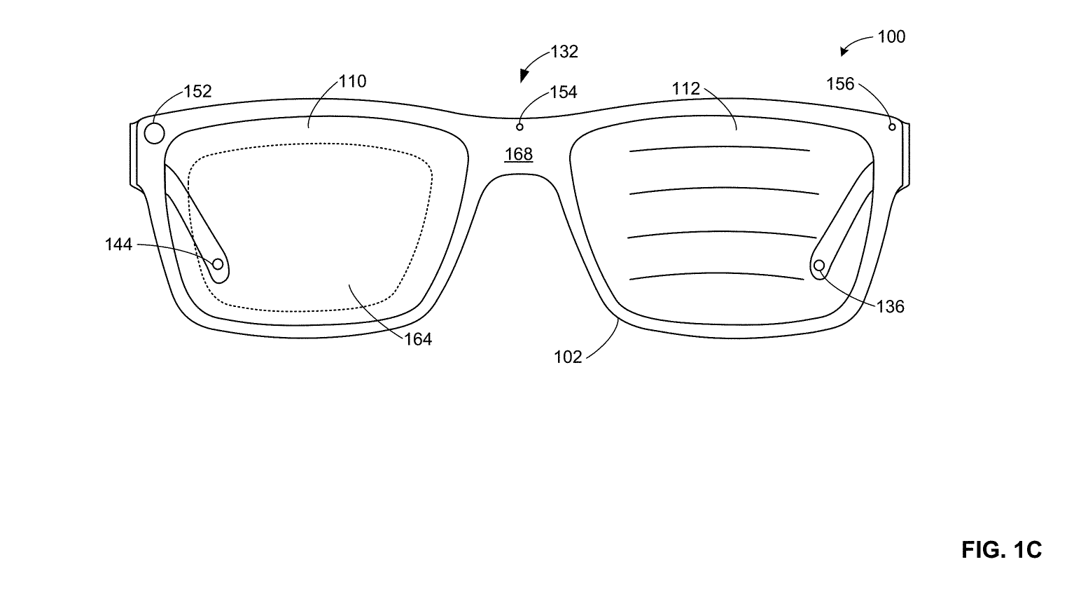

FIG. 1A is a right, perspective view of an example head-wearable apparatus 100 constructed in accordance with the teachings of this disclosure. FIG. 1B is a left, perspective view of the example head-wearable apparatus 100 of FIG. 1A. FIG. 1C is a front view of the example head-wearable apparatus 100 of FIGS. 1A and 1B.

Referring to FIGS. 1A-1C the head-wearable apparatus 100 of the illustrated example may be a wearable computing device configured to receive information, transmit information and/or to display information. The head-wearable apparatus 100 of the illustrated example is formed in the shape of glasses (e.g., smart glasses). In some examples, the head-wearable apparatus 100 may be in the form of goggles, a shield (e.g., a unitary lens, a one-piece glass or plastic lens), and/or another wearable device that may be interposed in a viewing angle of a user when the head-wearable apparatus 100 is worn by a user.

The head-wearable apparatus 100 of the illustrated example includes a frame 102, a first stem 104 (e.g., a right-side ear piece) and a second stem 106 (e.g., a left-side ear piece). The frame 102 of the illustrated example includes a nose support 108 to provide comfort and/or support when the head-wearable apparatus 100 is worn by a user. In some examples, to improve user comfort, the nose support 108 may be adjustable relative to the frame 102. To support or carry a first lens 110 and a second lens 112, the frame 102 of the illustrated example defines a first body 114. The first body 114 includes a first rim 116, a second rim 118 and a bridge 120 to couple the first rim 116 and the second rim 118. The first rim 116 defines an opening to receive the first lens 110 and the second rim 118 defines an opening to receive the second lens 112.

To secure the head-wearable apparatus 100 to a user, the head-wearable apparatus 100 of the illustrated example includes the first stem 104 and the second stem 106. Specifically, the first stem 104 of the illustrated example defines a second body 122 having a first or temple portion 124a and a second or tip portion 126a. Likewise, the second stem 106 of the illustrated example defines a third body 128 having a second or temple portion 124b and a third or tip portion 126b. The temple portions 124a and 124b of the respective second body 122 and the third body 128 of the illustrated example have a straight (e.g., linear) profile and the tip portions 126a and 126b have a curvilinear or arcuate profile in a direction along a longitudinal axis of the first stem 104 and the second stem 106. The first stem 104 and the second stem 106 of the illustrated example define a dimensional characteristic (e.g., a horizontal distance between inner sides of the tip portions 126a and 126b) between which a head of user may be positioned. To accommodate different sized heads of users and thereby improve user comfort characteristic(s), each of the first stem 104 and the second stem 106 of the illustrated example can move, bend or flex relative to the frame 102 and/or each other (e.g., away from or towards each other) to vary (e.g., increase or decrease) the distance between the first stem 104 and the second stem 106.

The head-wearable apparatus 100 of the illustrated example is shown in a use position in FIGS. 1A-1C. To move the head-wearable display apparatus between the use position and a stored or folded position (e.g., a non-use position), each of the first stem 104 and the second stem 106 are pivotally coupled to the frame via a hinge 130 (e.g., a hinge pin). The hinge 130 of the illustrated example enables the first stem 104 and the second stem 106 to fold relative (e.g., toward) to the frame 102. In some examples, the first stem 104 and the second stem 106 of the illustrated example may be removably coupled to the frame 102 via the respective hinges 130. In this manner, the first stem 104 may be removed from the frame 102 and may be interchangeable with another stem. In some examples, the head-wearable apparatus 100 does not fold to a stored or folded position. In other words, the frame 102 and the first stem 104 and the second stem 106 are fixedly coupled (e.g., integrally coupled, not pivotally coupled) relative to each other.

The first lens 110 and the second lens 112 of the illustrated example are carried by the first rim 116 and the second rim 118 of the frame 102, respectively. The first lens 110 and the second lens 112 of the illustrated example are sufficiently transparent (e.g., fully transparent, partially transparent, and/or any other clarity/transparency variation) to allow a user to see the environment through the first lens 110 and/or the second lens 112. The first lens 110 and/or the second lens 112 may be formed from glass, plastic and/or any other suitable material(s).

As described in greater detail below, the head-wearable apparatus 100 of the illustrated example is implemented via one or more electronic components 132. For example, the electronic components 132 may include, but are not limited to, an input/output (I/O) interface 134 (e.g., a micro universal serial bus (micro USB) connector, a thunderbolt connector, etc.), an intra-bone conduction speaker 136, a speaker 138 (e.g., an audio speaker), a microphone 140 as shown in FIG. 1A, a projection system 142, a heart rate sensor 144, a controller 146, a power source 148, a communication module 150 (e.g., an antenna, a WiFi antenna, a Bluetooth antenna, a near-field antenna, etc., to communicate with external devices (e.g., a tablet, a mobile device, etc.) as shown in FIG. 1B, a camera 152, an infrared (IR) sensor 154 (e.g., active IR sensor, a passive IR sensor, etc.) and an optical sensor 156 as shown in FIG. 1C, and/or any other sensor(s) and/or electronic component(s) such as, for example, a gyroscope, an accelerometer, a magnetometer, a humidity sensor, temperature sensor, etc.

To project or overlay an image (e.g., a digital image) adjacent (e.g., over) the first lens 110, the head-wearable apparatus 100 of the illustrated example employs the projection system 142. The projection system 142 of the illustrated example may be a projector or optical engine (e.g., a micro-projector, a pico-projector, a retina projector, retinal scan device, etc.) and/or any other projection system or image generator that is coupled with different types of relay optics placed in a field of view of a user that are used to redirect the projection light into a human eye of a user wearing the head-wearable apparatus 100. For example, the projection system 142 of the illustrated example interposes an image in a viewing angle of a user to enable the user wearing the head-wearable apparatus 100 to see the environment through the first lens 110 and/or the second lens 112 and see, simultaneously, imagery (e.g., digital imagery) across at least a portion of the first lens 110 generated by the projection system 142. In some examples, the image may appear (e.g., as a holographic image) between a user's eye and the first lens 110.

To project light and generate an image toward the first lens 110, the projection system 142 of the illustrated example includes an image generator 158. For example, the image generator 158 of the illustrated example emits and/or projects a spectrum or frequency of light in the Red, Green, and/or Blue (RGB) light spectrum toward the first lens 110. The image generator 158 of the illustrated example includes a light source 160 and a projector 162 to project light toward and/or on the first lens 110. In some examples, the light source 160 is a light emitting diode (LED). In some examples, the projector 162 may be a scanning mirror (or a plurality of scanning mirrors) to reflect and redirect light from the light source 160 toward the first lens 110. In some examples, the scanning mirror may be a microelectromechanical system (MEMS) based scanning mirror. In some examples, the projection system 142 may be a panel micro display such as, for example, a liquid crystal display (LCD), a thin-film transistor display (TFT), a microelectromechanical system display (MEMS), an organic light emitting diode (OLED), and/or any other projection system or image generator. In some examples, the image generator 158 and/or more generally the projection system 142 provides means for generating an image. In the illustrated example, the projection system is an in-plane projection system integrally formed with (e.g., overmolded with) with the first stem 104. In some examples, however, the projection system 142 may be removably coupled to the first stem 104 and/or the frame 102. For example, the first stem 104 may include a connector (e.g., a female portion of a micro-USB connector) to receive a corresponding connector (e.g., a male portion of a micro-USB connector) of a projection system that removably couples or attaches to (e.g., an exterior surface) of the first stem 104.

To provide a projection surface on which an image is to be displayed, (e.g., at least a portion of) the first lens 110 of the illustrated example includes a reflective surface or reflective material 164. The reflective material 164 of the illustrated example can display an image or graphic when light (e.g., a spectrum or frequency of light in the Red, Green, Blue (RGB) light spectrum) projects from the image generator 158 towards or onto the reflective material 164 of the first lens 110. In some examples, the image generator 158 overlays or interposes an image (e.g., holographic image) in a portion (e.g., an area) that is within a perimeter defined by the reflective material 164. The reflective material 164 of the first lens 110 may include, for example, a holographic film or holographic optical element (e.g., a transparent or semi-transparent holographic film) that provides a reflective surface for displaying a holographic image when the image generator 158 projects light on the reflective material 164. In some examples, although the entire surface area of the first lens 110 may include a holographic film or layer, only a portion of the first lens 110 (e.g., a holographic film) may be configured (e.g., recorded) to reflect a specific frequency (e.g., RGB frequency) of light provided by the image generator 158. In other examples a portion of the lens may be configured to reflect a range of frequencies (e.g. only G, but not R nor B). Thus, an image may overlay only a portion of a total area of the first lens 110 (e.g., the first lens) even when light from the image generator 158 projects across an entire surface area of the first lens 110. The reflective material 164 (e.g., the holographic film) may be encapsulated with the first lens 110, laminated with the first lens 110, and/or applied to the first lens 110 using any other suitable manufacturing technique(s). In some examples, the second lens 112 and may include a reflective material (e.g., a holographic film).

To control one or more settings or parameters of the light source 160 and/or a position of the projector 162 (e.g., a scanning mirror), the head-wearable apparatus 100 of the illustrated example includes the controller 146. The controller 146 may command an actuator to move or rotate a position of the projector 162 and/or may adjust (e.g., increase or decrease) one or more settings or parameters (e.g., a brightness) of the light source 160. In some examples, the controller 146 receives ambient light conditions from an optical sensor 156 (FIG. 1C). Specifically, the optical sensor 156 is positioned on an outer surface of the frame 102 and oriented in a direction away from a user when a user is wearing the head-wearable apparatus 100.

To provide electrical power to the image generator 158, the head-wearable apparatus 100 includes the power source 148. The power source 148 of the illustrated example is a battery (e.g., a rechargeable lithium ion battery). In some examples, the power source 148 may be integrated with the image generator 158.

In some examples, the first stem 104 and/or the second stem 106 may support only one or two electronic components 132. For example, in some such examples, the second stem 106 includes the power source 148 and/or the controller 146 (e.g., a processing circuitry provided by a main processor)) and the first stem 104 is interchangeable with a plurality of first stems, where each of the first stems include a different feature or electronical component 132 that can be used with the head-wearable apparatus 100. For example, a first one of the first stems may include the image generator 158, a second one of the first stems may include the intra-bone conduction speaker 136, a third one of the first stems may include the speaker 138, a fourth one of the first stems may include any other electrical component(s), etc. To this end, a user may interchange different ones of the electronical components 132 with the head-wearable apparatus 100 by interchanging the different first stems with the frame 102.

As described in greater below, circuitry implementing the one or more electronic components 132 of the illustrated example is integrally formed with or at least partially defines a structure or framework 166 (e.g., an essential support structure) of at least one of the frame 102, the first stem 104 or the second stem 106. In other words, absent the circuitry, the frame 102, the first stem 104 and/or the second stem 106 would not take shape. As a result of implementing or forming the circuitry as the structure (e.g., a framework, a scaffold, etc.) of the head-wearable apparatus 100, the head-wearable apparatus 100 of the illustrated example may be formed with a smaller dimensional profile or form factor (e.g., compared to conventional smart glasses) that significantly improves an aesthetic and/or fashionable appeal of the head-wearable apparatus 100. In this manner, the electronic components 132 of the head-wearable apparatus 100 are hidden or provided in a contour or shape of the frame 102, the first stem 104 and the second stem 106 and do not interfere with or effect an aesthetic and/or fashionable appeal of the head-wearable apparatus 100. For example, the circuitry implementing the one or more electronic components 132 may define one or more outer surfaces 168 of the head-wearable apparatus 100. In some examples, the circuitry may be structured to define at least one of the frame 102, the first stem 104 or the second stem 106, while another one of the frame 102, the first stem 104 or the second stem 106 may be formed as a conventional frame or stem (e.g., a frame composed of plastic without circuitry). In some examples, the frame 102 of the illustrated example may be hollow and/or may include one or more cavities or channels to receive (e.g., route) electrical contacts, electrical wires, and/or other electrical circuitry and/or may include conductive traces or inks to electrically couple the first stem 104 (e.g., the projection system 142) and the second stem 106 (e.g., the power source 146).

As shown in FIGS. 1A-1C, the head-wearable apparatus 100 of the illustrated example has a relatively identical or similar form factor as conventional eyewear or glasses. For example, the head-wearable apparatus 100 does not include housings or conventional electronic components (e.g., a projector) that typically attaches to an exterior surface of the frame 102, the first stem 104 or the second stem 106. In other words, the one or more electronic components 132 of the head-wearable apparatus 100 of the illustrated example are integrally formed with and/or at least partially define an outer structure, profile or shape of at least one of the frame 102, the first stem 104 or the second stem 106. In this manner, the head-wearable apparatus 100 of the illustrated example maintains a form factor of conventional glasses. For example, the first stem 104 and/or the second stem 106 may have a dimensional length 170 of approximately between 120 to 200 millimeters, a dimensional height 172 approximately between 20 to 50 millimeters, and a dimensional thickness 174 of approximately between 10 to 30 millimeters. The bridge 120 of the illustrated example may have a dimensional length 176 of approximately between 15 to 30 millimeters, and the first rim 116 and the second rim 118 of the illustrated example may have a dimensional thickness 178 of approximately between 15 to 30 millimeters.

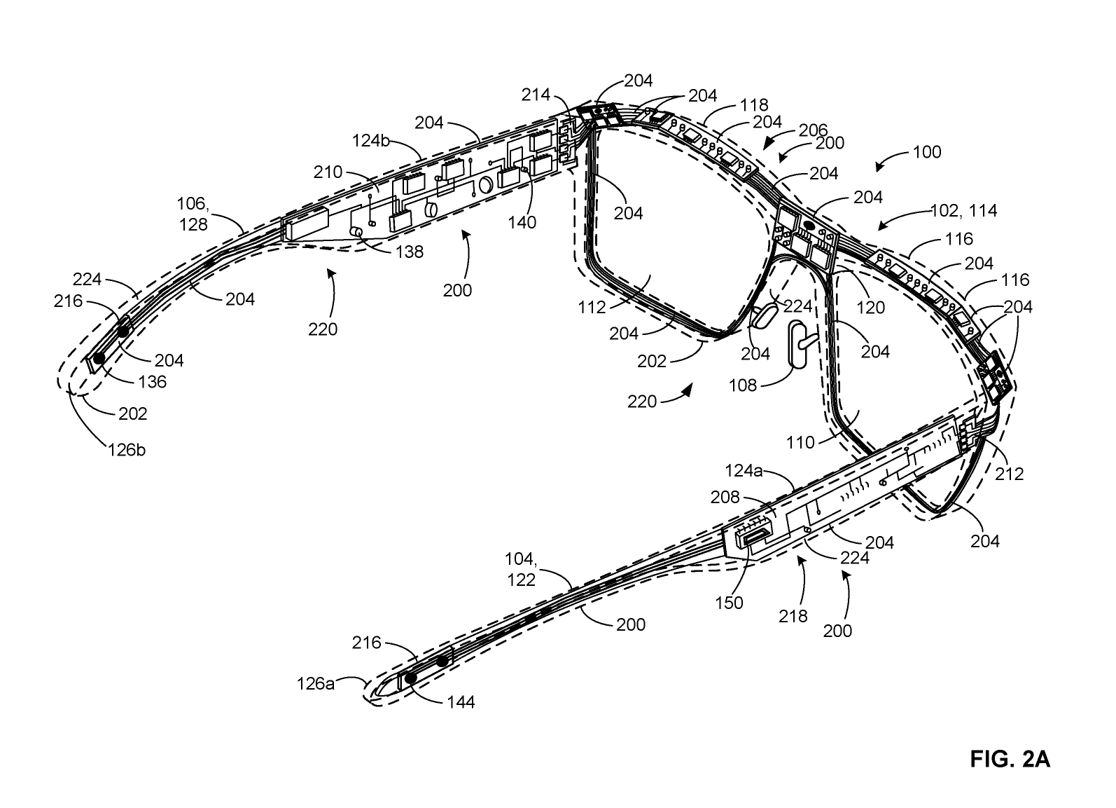

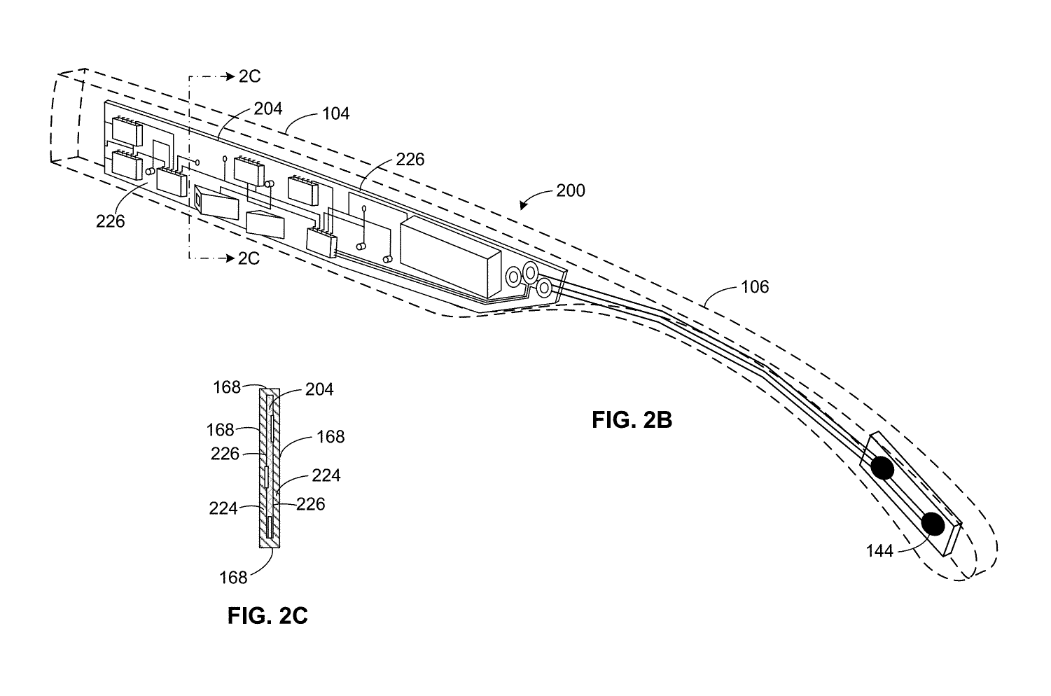

FIG. 2A is a perspective view of the head-wearable apparatus 100 of FIG. 1A, but showing circuitry 200 that implements the one or more electronic components 132 and/or the framework 166 of the head-wearable apparatus 100 of FIGS. 1A-1C. FIG. 2B is a perspective view of the first stem 104 of FIGS. 1A-1C. FIG. 2C is a cross-sectional view of the example first stem 104 taken along line 2C-2C of FIG. 2B.

Referring to FIGS. 2A-2C, the circuitry 200 implementing (e.g., one or more electronic components of) the head-wearable apparatus 100 of the illustrated example is integrally formed with at least one of the frame 102, the first stem 104, or the second stem 106. To this end, the circuitry 200 of the illustrated example provides structural support or framework for at least one of the frame 102, the first stem 104 or the second stem 106 of the head-wearable apparatus 100. For example, the circuitry 200 of the illustrated example defines an overall shape or profile (e.g., the framework 166) of the frame 102, the first stem 104 and the second stem 106 of the head-wearable apparatus 100. For example, the overall shape or profile 202 of the head-wearable apparatus 100 of FIG. 2 is shown in dashed line.

To define a structural shape or framework 166 of the frame 102, the first stem 104 and/or the second stem 106, the circuitry 200 of the illustrated example is formed on one or more circuit boards 204. For example, the circuit boards 204 may be shaped to define at least a portion of a profile of the frame 102, the first stem 104 or the second stem 106. In some examples, the circuit boards 204 may be planar and/or curved to form the rims 116 and 118, the temple portions 124a and 124b, the tip portions 126a and 126b, etc. In some examples, an overall structural shape or profile of the head-wearable apparatus 100 of the illustrated example may be formed via a single circuit board (e.g., a single rigid-flex circuit board). In some such examples, the signal circuit board may be overmolded (e.g., via injection molding) with a material (e.g., a plastic) to define the overall profile or shape (e.g., a final shape) of the head-wearable apparatus 100. In some such examples, the circuit board may be formed via a mold used to provide the overmolded material.

In some examples, two or more circuit boards 204 collectively define the overall structural shape, framework or profile of the head-wearable apparatus 100. For example, a first circuit board 206 may be shaped to define at least a portion of the first body 114 defining the frame 102 (e.g., the first rim 116, the second rim 118 and/or the bridge 120). A second circuit board 208 may be shaped to define at least a portion of the second body 122 of the first stem 104. Similarly, a third circuit board 210 may be shaped or provided to define at least a portion of the third body 128 of the second stem 106. In this manner, the circuit boards 206, 208 and 210 collectively at least partially define the overall shape or profile of the head-wearable apparatus 100. The one or more circuit boards 206, 208 and 210 of the illustrated example may be a rigid circuit board, a rigid-flex circuit board, a flexible circuit board and/or any other type of circuit board(s). For example, a rigid circuit board may be used to define the temple portions 124a and 124b of the respective first stem 104 and the second stem 106, and a flex circuit board may be used to define the first rim 116 and the second rim 118 of the frame 102.

To electrically or communicatively couple the first circuit board 206, the second circuit board 208 and the third circuit board 210, the head-wearable apparatus 100 of the illustrated example includes a first connector 212 and a second connector 214. The first connector 212 of the illustrated example electrically couples the first circuit board 206 of the frame 102 and the second circuit board 208 of the first stem 104. The second connector 214 of the illustrated example electrically couples the first circuit board 206 of the frame 102 and the third circuit board 210 of the second stem 106. Thus, the first circuit board 206 of the illustrated example electrically and/or communicatively couples the second circuit board 208 and the third circuit board 210. In some examples, the frame 102, the first stem 104, the second stem 106 and/or the hinges 130 (e.g., at a hinge interface) may include one or more conductive contacts (e.g., pads or traces) or conductive ink to electrically couple the frame 102, the first stem 104 and the second stem 106 when the first stem 104 and the second stem 106 attach or couple to the frame 102. In some examples, as noted above, the frame 102 may be formed via a conventional frame (e.g., a conventional frame without circuitry). In some such examples, one or more wires may be provided in channels of the frame to electrically couple the second circuit board 208 and the third circuit board 210. In some examples, the first and second connectors 212 and 214 of the illustrated example may be implemented via a flex circuit, a rigid-flex circuit, a conductive trace, a three-dimensional conductive trace, conductive ink, etc. In some examples, the first and second connectors 212 and 214 may be needed when a rigid-flex circuit is employed. In some such examples, a portion (e.g., a flex portion) of the rigid-flex circuit forms or defines the connector. Thus, in some such examples, the first and second connectors 212 and 214 may be implemented by rigid-flex circuits positioned adjacent the first and second ends of the frame 102 and/or the respective ends of the first stem 104 and the second stem 106.

In some examples, each of the first, second and third circuit boards 206, 208 and 210 of the illustrated example may be formed by two or more circuit boards 204. For example, the first circuit board 206 may be formed via a first circuit board assembly 216, the second circuit board 208 may be formed via a second circuit board assembly 218, and/or the third circuit board 210 may be formed via a third circuit board assembly 220. Specifically, the first circuit board assembly 216 of the illustrated example may be formed to provide a shape corresponding to a shape of the frame 102 (e.g., a conventional frame of eyewear). The second circuit board assembly 218 of the illustrated example may be formed to provide a shape corresponding to a shape of the first stem 104 (e.g., a conventional stem of eyewear). Likewise, the third circuit board assembly 220 of the illustrated example may be formed to provide a shape corresponding to the shape of the second stem 106 (e.g., a conventional frame of eyewear). The first circuit board assembly 216, the second circuit board assembly 218, and/or the third circuit board assembly 220 of the illustrated example may be formed by one or more rigid circuit boards, one or more flexible circuit boards, one or more rigid-flex circuits, a combination thereof, and/or any other type of circuit board(s).

For example, the first circuit board assembly 216 of the illustrated example includes first flex and rigid-flex circuit boards defining the first rim 116, second flex and rigid-flex circuit boards defining the second rim 118, and a rigid circuit board defining the bridge 120. Additionally, the first circuit board assembly 216 of the illustrated example includes one or more flex circuit boards to electrically couple the first rigid-flex circuit board, the second rigid-flex circuit board, and the rigid circuit board.

In the illustrated example, the first rim 116 includes a circuit board 204 that may implement the camera 152, a circuit board 204 that may implement the IR sensor 154, and a circuit board 204 that may implement the optical sensor 156. The second circuit board assembly 218 of the illustrated example includes a rigid circuit board to define the temple portion 124a and a rigid-flex circuit board to define the tip portion 126a of the first stem 104. For example, the rigid circuit board defining the temple portion 124a of the first stem 104 may include circuitry to implement the projection system 142 and/or the I/O interface 134. The flex circuit board defining the tip portion 126a of the first stem 104 may include circuitry to implement the heart rate sensor 144. Additionally, the second circuit board assembly 218 of the illustrated example includes a flex circuit board to electrically couple the rigid-flex circuit board and the rigid circuit board of the first stem 104.

The third circuit board assembly 220 of the illustrated example includes a rigid circuit board to define the temple portion 124b and a flex circuit board to define the tip portion 126b of the second stem 106. For example, the rigid circuit board defining the temple portion 124b of the second stem 106 may include circuitry to implement the power source 148, the speaker 138, the microphone 140, the controller 146 and/or any other sensor such as, for example an accelerometer, and the flex circuit board defining the tip portion 126b of the second stem 106 may include circuitry to implement the intra-bone conduction speaker 136. Additionally, the third circuit board assembly 220 of the illustrated example includes a flex circuit board to electrically couple the rigid circuit board defining the temple portion 124b and the rigid-flex circuit board defining the tip portion 126b. In some examples, surfaces of the frame 102, the first stem 104 and/or the second stem 106 may be lined, layered with, and/or formed from conductive material(s) (e.g., electrically conductive traces, copper traces, etc.) to provide an electrical path between the circuit boards 204.

The circuit boards 204 of the illustrated example defining the structure or framework 166 (FIGS. 1A-1C) of the head-wearable apparatus 100 define one or more outer surfaces 168 (FIGS. 1A-1C) of the head-wearable apparatus 100. For example, the first circuit board 206 defines at least one outer surface 168 of the frame 102. In some examples, the first circuit board 206 defines all outer surfaces 168 of the frame 102. Similarly, in some examples, the second circuit board 208 defines at least one outer surface 168 of the first stem 104. In some examples, the second circuit board 208 defines all outer surfaces 168 of the first stem 104. Likewise, in some examples, the third circuit board 210 defines at least one outer surface 168 of the second stem 106. In some examples, the third circuit board 210 defines all outer surfaces 168 of the second stem 106.

To cover or protect one or more electronic components and/or the circuit boards 204, the head-wearable apparatus 100 of the illustrated example includes an outer layer 224 (e.g., a protective outer material) (FIG. 2C) that covers or protects one or more surfaces 226 of the circuit boards 204 defining the frame 102, the first stem 104 and/or the second stem 106. Thus, in some such examples, the outer layer 224 defines the outer surfaces 168 of the head-wearable apparatus 100. For example, FIG. 2B illustrates the outer layer 224 defining the outer surfaces 168 of the first stem 104. The outer layer 224 of the illustrated example may be composed of a material including, but not limited to, a rubber, a plastic, a metal (e.g., aluminum), an epoxy, and/or any other suitable materials. In some examples, one or more circuit boards 204 disclosed herein may include recesses or roughed surface areas to increase adhesion characteristic(s) when the outer layer 224 is attached to (e.g., overmolds with) the circuit boards 204. The circuit boards 204 of the illustrated example may be overmolded with the outer layer 224 via injection molding manufacturing processes or techniques. In some examples, the circuit board 204 defining the overall shape or framework 166 of the head-wearable apparatus 100 may be formed via one or more rigid-flex circuit boards that bend or flex to form the profile of the head-wearable apparatus 100 when the circuit boards 204 are inserted in a mold used to overmold the circuit board(s) with the outer layer 224 via an injection molding process. In some examples, the outer layer 224 may be sprayed, disposed on, or otherwise deposited on the circuit boards 204, and/or may be applied to the circuit boards 204 using any other manufacturing processes or techniques.

In some examples, the outer layer 224 may be provided on one or more sides or surfaces 226 of the circuit boards 204 during production or manufacturing of the circuit boards 204. In some examples, the outer layer 224 may be a plate that couples or attaches to the circuit boards 204. For example, the outer layer 224 may be composed of rubber, plastic, metal, carbon fiber and/or any other material(s). For example, the outer layer 224 may be attached to the circuit boards 204 via mechanical fasteners (e.g., fasteners), chemical fasteners (e.g., adhesive) and/or any other fastener. In some examples, a first plate (e.g., an aluminum or carbon fiber plate) may be attached to a first side of the circuit board 204 and/or a second plate may be attached to a second side of the circuit board 204 opposite the first side such that the circuit board 204 is positioned between the first and second plates. In some examples, the outer layer 224 and/or the outer surfaces 226 may be formed of any suitable material, including, for example, plastic, metal, rubber, titanium, aluminum, fiber-reinforced material (e.g., a carbon fiber composite) and/or any other suitable material(s) and/or any combinations thereof.

The circuit boards 204 of the illustrated example may be formed from various material(s) and/or various manufacturing technique(s). In some examples, the circuit boards 204 may be made with a photolithographic technology and/or processes. For example, rigid circuit boards may be printed circuit boards composed of a glass reinforced epoxy laminate (e.g., a copperclad laminate). For example, glass reinforced epoxy laminate may be a composite material composed of woven fiberglass cloth with an epoxy resin binder that is flame resistant (e.g., self-extinguishing). For example, the circuit boards 204 (e.g., a rigid printed circuit board) of the illustrated example may be formed from FR-4 glass reinforced epoxy laminate.

In some examples, the circuitry 200 (e.g., circuit boards 204 and/or the electronic components 132) may be formed via flexible, plastic substrates such as polyimide, PEEK, or transparent conductive polyester film, and/or a combination of flexible layers and rigid layers (e.g., rigid-flex circuits). The flexible circuit boards or flexible electronic assemblies may be manufactured using similar components used with the rigid printed circuit boards and can conform, flex or bend to a desired shape. In some examples, the circuit boards 204 and/or the frame 102, the first stern 104, the second stem 106 and/or the head-wearable apparatus 100 may be formed via additive manufacturing (e.g., three-dimensional printing). In some examples, the circuity may be formed via conductive inks, indium tin oxide (ITO) printed circuit boards, single-sided circuit boards, double-sided circuit boards, multi-layer circuit boards, metal clad printed circuit boards (MCPCB), insulated metal substrate printed circuit boards and/or any other type of circuit boards.

Although the head-wearable apparatus 100 of the illustrated example includes circuit boards 204 to define the frame 102, the first stem 104 and the second stem 106, in some examples, the frame 102, the first stem 104 and the second stem 106 may be formed via a first housing removably coupled to a second housing. The circuit boards 204 defining the circuitry 200 of the electronic components 132 may be positioned or inserted in a cavity formed by the first housing and the second housing. In this manner, the electronic components 132 of the head-wearable apparatus 100 may be positioned inside the frame 102, the first stem 104 and/or the second stem 106. In other words, the circuit boards may be assembled with a housing that defines the frame 102, the first stem 104 and/or the second stem 106.

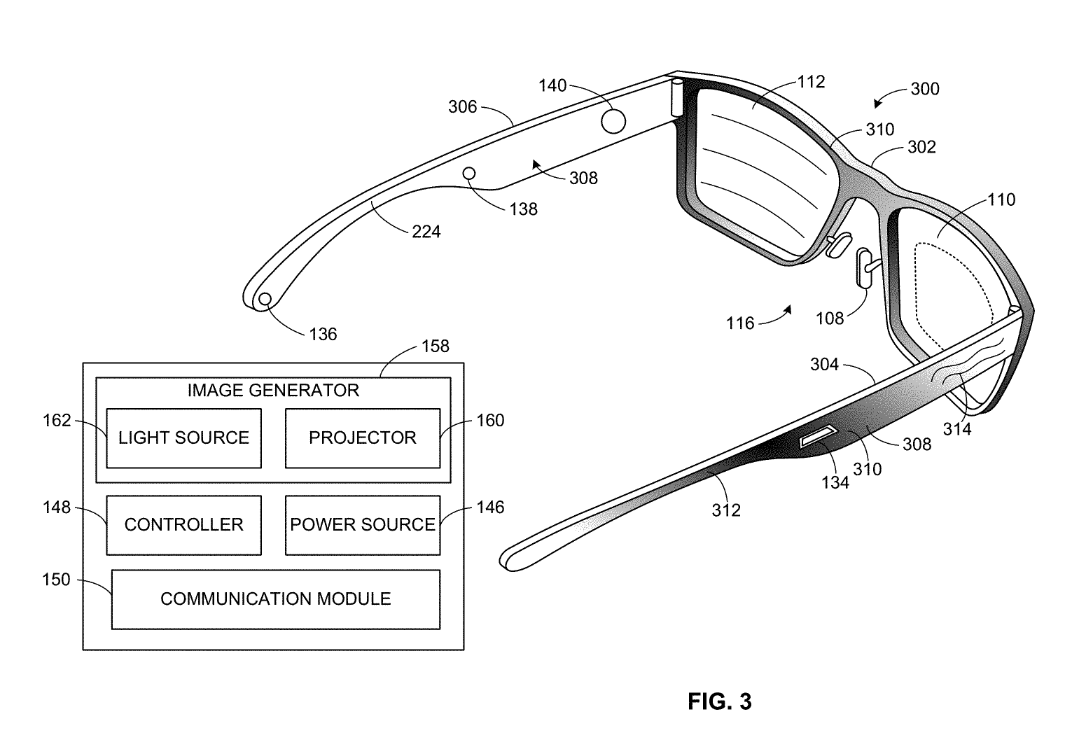

FIG. 3 is a perspective view of another example head-wearable apparatus 300 disclosed herein. The head-wearable apparatus 300 of the illustrated example is substantially similar to the head-wearable apparatus 100 of FIGS. 1A-1C and 2A-2C. Those components of the example head-wearable apparatus 300 that are substantially similar or identical to the components of the example head-wearable apparatus 100 described above and that have functions substantially similar or identical to the functions of those components will not be described in detail again below. Instead, the interested reader is referred to the above corresponding descriptions. To facilitate this process, similar reference numbers will be used for like structures. For example, the head-wearable apparatus 300 of the illustrated example includes the first lens 110, the second lens 112, the electronic components 132 including, for example, the I/O interface 134, the intra-bone conduction speaker 136, the speaker 138, the microphone 140, the projection system 142 (e.g., the image generator 158, the light source 160 and the projector 162), the controller 146, the power source 148, and the communication module 150.

The head-wearable apparatus 300 of the illustrated example includes a frame 302, a first stem 304 and a second stem 306. The frame 302, the first stem 304 and the second stem 306 of the head-wearable apparatus 300 of the illustrated example include circuitry implementing one or more electronic components 132 that are composed of insulated metal substrates 308. Forming the circuitry via insulated metal substrates 308 facilitates forming the circuit boards with a contour shape or profile of (e.g., a curved or arcuate profile of a first rim and a second rim of) the frame 302 and/or (e.g., a curved profile along the longitudinal axis of) the first stem 304 and the second stem 306. For example, at least one outer surface 310 of the frame 302, first stem 304 and the second stem 306 includes a metal surface 312 (e.g., an aluminum surface). In some examples, the outer layer 224 may be provided on exposed surfaces of the circuitry (e.g., a non-metal surface of the circuit board) not covered or defined by the metal surface 312. The outer layer 224 may define outer or exterior surfaces of the frame 302, the first stem 304 and/or the second stem 306. In some examples, the metal surface 312 improves an aesthetic appeal of the head-wearable apparatus 300 and/or improves (e.g., increases) heat dissipation characteristic(s) of the circuitry. In some examples, indicia 314 (e.g., logo's, lettering, symbols, etc.) may be etched (e.g., via laser etching), patterned and/or otherwise provided to the outer surface to improve aesthetic and/or fashionable appeal of the head-wearable apparatus 300. In some examples, the insulated metal substrates 308 may be configured such that the metal surface 312 is positioned over or covers all exposed surfaces (e.g., exterior surfaces) of the circuitry instead of the outer layer 224. In some such examples, all of the outer or exterior surfaces of the frame 302, the first stem 304 and/or the second stem 306 of the head-wearable apparatus 300 may have a metal surface or finish. For example, in some such examples, the circuitry can be positioned between two metal (e.g., aluminum) plates and the metal plates define the outer or exterior surfaces of the head-wearable apparatus 300. In some examples, the circuitry defining the frame 302, the first stem 304 and/or the second stem 306 may be formed from carbon fiber, alloys and/or any other materials.

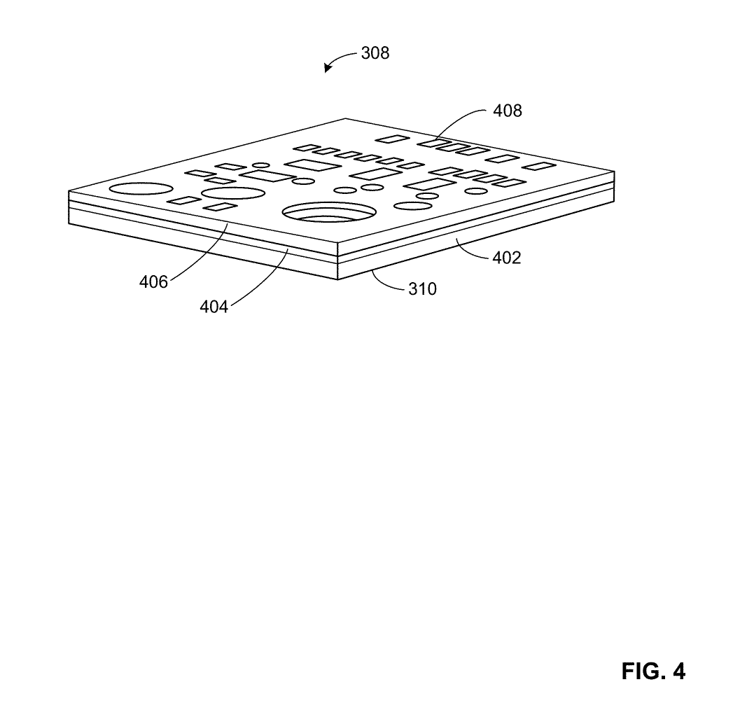

FIG. 4 is a perspective view of the example insulated metal substrate 308 of FIG. 3. The circuitry of the illustrated example includes a metal core board or carrier 402 providing the metal surface 312 (e.g., an aluminum board), an insulation material 404 (e.g., a polymer or ceramic), and a copper foil 406 defining circuitry 408. The metal core board or carrier 402 of the illustrated example defines the outer surface 310 of the first stem 304. In some examples, the insulated metal substrates 308 may be stacked such that the circuitry of two insulated metal substrates 308 faces each other and the metal core boards or carriers 402 define opposing outer surfaces 310 of the frame 302, the first stem 304 and/or the second stem 306. In some such examples, an insulation layer may be positioned between the circuitry 408 (e.g., the copper foil 406) of the two adjacent insulated metal substrates 308.

As noted above, the example head-wearable apparatus 100, 400 disclosed herein may be formed using any known circuits and/or fabrication techniques. For example, the circuitry and/or the frame 102, 302, the first stem 104, 304, and/or the second stem 106, 306 of the head-wearable apparatus 100, 300 disclosed herein may be formed via three dimensional 3-D printed circuit board techniques. Such techniques enable circuitry to be formed on a two-dimensional substrate (e.g., or foil or laminate) and the two-dimensional substrate may be subsequently folded or formed into a three-dimensional body forming the shape or profile of, for example, the first body 114 defining the frame 102, 302, the second body 122 defining the first stem 104, 304 and/or the third body 128 defining the second stem 106, 306.

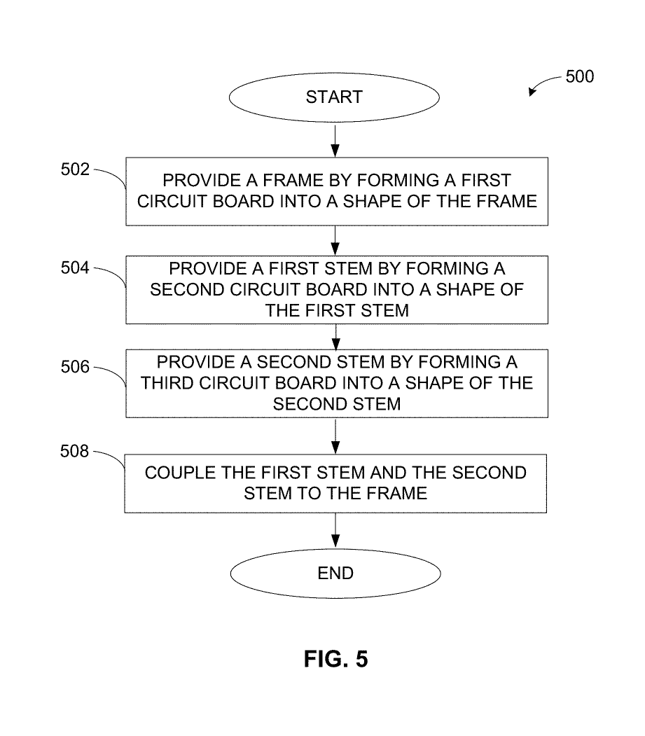

FIG. 5 is a flowchart of an example method 500 that may be used to manufacture an example head-wearable apparatus such as the example head-wearable apparatus 100 of FIGS. 1A-1C and the example head-wearable apparatus 300 of FIGS. 3 and 4. While an example manner of manufacturing the example head-wearable apparatus 100, 300 has been illustrated in FIG. 5, one or more of the steps and/or processes illustrated in FIG. 5 may be combined, divided, re-arranged, omitted, eliminated and/or implemented in any other way. Further still, the example method 500 of FIG. 5 may include one or more processes and/or steps in addition to, or instead of, those illustrated in FIG. 5, and/or may include more than one of any or all of the illustrated processes and/or steps. Further, although the example method is described with reference to the flow chart illustrated in FIG. 5, many other methods of manufacturing the example head-wearable apparatus 100, 300 may alternatively be used.

To begin the example assembly process of FIG. 5, a frame 102, 302 is provided by forming a first circuit board 206 into a shape of the frame 102, 302 (block 502). A first stem is provided by forming a second circuit board 208 into a shape or profile of the first stem 104, 304 (block 504) and a second stem 106, 306 is provided by forming a third circuit board 210 into a shape or profile of the second stem 106, 306 (block 506). For example, the first circuit board 206, the second circuit board 208 and/or the third circuit board 210 may be a substantially planar, flexible or semi-rigid board (e.g., a rigid-flex circuit board) that is positioned in mold configured to form the first circuit board 206 into the shape of the frame 102, 302, the second circuit board 208 into the shape of the first stem 104, 304, and/or the third circuit board 210 into the shape of the second stem 106, 306. In some examples, the first circuit board 206, the second circuit board 208 and/or the third circuit board 210 may be overmolded with the outer layer 224. In some examples, the first circuit board 206, the second circuit board 208 and/or the third circuit board 210 may be formed from an insulated metal substrate 308 configured or formed into the shape of the frame 102, 302, the first stem 104, 304 and/or the second stem 106, 306. After the frame 102, 302, the first stem 104, 304 and the second stem 106, 306 are formed, the first stem 104, 304 and the second stem 106, 306 are coupled to the frame 102, 302 (block 508). In some examples, the circuitry 200, 408 may be formed on a circuit board or substrate, which is then overmolded with the outer layer 224 (e.g., via injection molding). In some such examples, the head-wearable apparatus 100, 300 disclosed herein may be formed via a two-step manufacturing process.

From the foregoing, it will be appreciated that example methods, apparatus and articles of manufacture have been disclosed that greatly improve aesthetic and fashionable appeal of head-wearable apparatus (e.g., eyewear or glasses). Improving the aesthetics is greatly important to provided fashionable head-wearable apparatus such as glasses.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. Glasses comprising:
a frame to carry a first lens, the frame defining a first body;
a first stem and a second stem coupled to the frame, the first stem and the second stem defining a second body and a third body, respectively; and
a circuit board defining a circuit to implement the glasses, the circuit board being shaped to define a framework of at least one of the first body of the frame, the second body of the first stem or the third body of the second stem.

2. The glasses of claim 1, wherein the circuit board includes at least one of a rigid circuit board, a flex circuit board or a flex-rigid circuit board.

3. The glasses of claim 1, wherein the circuit board is formed into a profile defining the second body of the first stem.

4. The glasses of claim 3, wherein the second body has a temple portion and a tip portion, the circuit board including a rigid circuit board to define the temple portion and at least one of a flexible circuit board or a flex-rigid circuit board to define the tip portion.

5. The glasses of claim 4, wherein the rigid circuit board includes a projection system circuit to implement a projection system of the glasses, and the at least one of the flexible circuit or the flex-rigid circuit implements a heart rate sensor of the glasses located at the tip portion.

6. The glasses of claim 1, wherein the circuit board includes a circuit board assembly formed into a shape defining the first body of the frame.

7. The glasses of claim 6, wherein the first body includes a first rim defining a first opening to receive the first lens, a second rim defining a second opening to receive a second lens, and a bridge to couple the first rim and the second rim, the circuit board assembly including a rigid circuit board to define the bridge and at least one of a flexible circuit board or a flex-rigid circuit board to define at least one of the first rim or the second rim.

8. A head-wearable apparatus comprising:
a frame defining a first body composed of a first circuit board assembly, the frame to carry a lens;
a first stem defining a second body composed of a second circuit board assembly, the first stem to couple to a first side of the frame; and
a second stem defining a second body composed of a third circuit board assembly, the second stem to couple to a second side of the frame opposite the first side.

9. The head-wearable apparatus of claim 8, wherein the first circuit board assembly, the second circuit board assembly, or the third circuit board assembly includes at least one of a rigid circuit board, a rigid-flex circuit board, or a flex circuit board.

10. The head-wearable apparatus of claim 8, further including a protective coating provided on at least one surface of the first circuit board assembly, the second circuit board assembly or the third circuit board assembly.

11. The head-wearable apparatus of claim 8, wherein the first circuit board assembly implements at least one of an optical sensor, an infrared sensor or a camera located on the frame, the second circuit board assembly implements a projection system located on the first stem that is to project an image on the lens carried by the frame, and the third circuit assembly implements at least one of a power source, a speaker, or a microphone located on the second stem.

12. The head-wearable apparatus of claim 8, wherein the first circuit board assembly defines at least one outer surface of the frame.

13. The head-wearable apparatus of claim 8, wherein the first circuit board assembly defines all outer surfaces of the frame.

14. The head-wearable apparatus of claim 8, wherein the second circuit board assembly defines at least one outer surface of the first stem.

15. The head-wearable apparatus of claim 8, wherein the second circuit board assembly defines all outer surfaces of the first stem.

16. The head-wearable apparatus of claim 8, wherein the third circuit board assembly defines at least one outer surface of the second stem.

17. The head-wearable apparatus of claim 8, wherein the third circuit board assembly defines all outer surfaces of the second stem.

18. The head-wearable apparatus of claim 8, wherein the frame includes a first rim to support a first lens, a second rim to support a second lens, and a bridge to couple the first rim and the second rim.

19. The head-wearable apparatus of claim 8, wherein each of the first stem and the second stem includes a temple portion and an ear tip.

20. A method of forming a head-wearable apparatus, the method comprising:
providing a frame to support a lens; and
providing a first stem by forming a first circuit board into a shape of the first stem, the first stem to couple to a first side of the frame of the head-wearable apparatus.

21. The method of claim 20, further comprising providing a second stem by forming a second circuit board into a shape of the second stem, the second stem to couple to a second side of the frame opposite the first side.

22. The method of claim 20, wherein the providing of the frame includes forming a third circuit board into a shape of the frame, the third circuit board to enable the frame to carry the lens of the head-wearable apparatus.

23. The method of claim 22, further including pivotally coupling the first stem to the first side of the frame via a hinge, and electrically coupling the first circuit board and the third circuit board via a conductive contact when pivotally coupling the first stem and the frame via the hinge.
